(19) United States
(12) Patent Application Publication
(10) Pub. No.: US 2024/0042876 A1
(43) Pub. Date: Feb. 8, 2024

(54) COOLING MODULE FOR A PLUG CONNECTOR PART, AND PLUG CONNECTOR PART

(71) Applicant: PHOENIX CONTACT E-MOBILITY GMBH, Schieder-Schwalenberg (DE)

(72) Inventors: Thomas FUEHRER, Blomberg (DE); Robert BABEZKI, Steinheim (DE)

(21) Appl. No.: 18/255,879

(22) PCT Filed: Nov. 11, 2021
(86) PCT No.: PCT/EP2021/081344

§ 371 Date: Jun. 5, 2023

(30) Foreign Application Priority Data
Dec. 9, 2020 (DE) 10 2020 132 724.2

(51) Int. Cl. B60L 53/302; B60L 53/18; B60L 53/16

(52) U.S. Cl. CPC B60L 53/302; B60L 53/18; B60L 53/16

(57) ABSTRACT

A cooling module for a plug connector part includes a main body having a cavity in which at least one terminal region is formed for electrical contacting by an electrical load line; at least one opening opening into the cavity via which a coolant can flow through the cavity; and a mounting surface for mounting an electrical load contact.

### CROSS-REFERENCE TO PRIOR APPLICATIONS

This application is a U.S. National Phase application under 35 U.S.C. § 371 of International Application No. PCT/EP2021/081344, filed on Nov. 11, 2021, and claims benefit to German Patent Application No. DE 10 2020 132 724.2, filed on Dec. 9, 2020. The International Application was published in German on Jun. 16, 2022 as WO/2022/122292 under PCT Article 21(2).

### FIELD

The invention relates to a cooling module for a plug connector part, and a plug connector part.

### BACKGROUND

Particularly in the field of e-mobility, the highest demands with respect to the current-carrying capacity and the associated thermal loads exist for plug-in connector parts and associated cable assemblies. At high DC charging currents, e.g., around 500 A, significant amounts of current heat are regularly released in all components of the conductive path. Power loads of up to 3,000 A are even envisioned for commercial vehicles in the future. Due to normative requirements, e.g., on contact size, and an always desired reduction in weight in the vehicle, e.g., through the smallest possible cable cross-sections, the dimensioning of the current-carrying components is on the one hand usually chosen to be as small as possible, but on the other, given the desired current-carrying capacities, the corresponding current loads can result in current densities that are considerably higher than usual empirical values in industrial electrical engineering.

One possibility of increasing the current-carrying capacity of plug and cable connections is cooling—in particular, an active cooling of load contacts and lines. For this purpose, for example, plug connectors with integrated fluid cooling of the load contacts and charging cables with integrated cooling of the load lines are used.

DE 10 2019 104 655 A1 describes a cooling housing provided with cooling ribs for high-current wiring. DE 10 2016 108 823 B4 describes an actively-cooled electrical line.

A technical challenge regularly results in actively-cooled line and plug connector systems where a coolant circuit and electrical lines are spatially separated from one another for functional reasons. Since, however, the cross-sections of the electrical lines can only carry high current loads if they are cooled as effectively as possible, the conductor cross-sections usually have to be dimensioned correspondingly large in order to avoid the danger of overheating. However, this makes further weight reduction more difficult.

### SUMMARY

In an embodiment, the present invention provides a cooling module for a plug connector part, comprising: a main body having a cavity in which at least one terminal region is formed for electrical contacting by an electrical load line; at least one opening into the cavity via which a coolant can flow through the cavity; and a mounting surface configured to mount an electrical load contact.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a view of a vehicle with a plug connector part designed as a vehicle charging socket which is connected to a charging station via a cable;

FIG. 2 shows a view of the plug connector part designed as a vehicle charging socket according to FIG. 1;

FIG. 3 shows an exploded view of parts of the plug connector part according to FIG. 2;

FIGS. 4A to 4F show different views of a cooling module of the plug connector part according to FIG. 2 with a load contact mounted thereon and two supply lines connected thereto;

FIGS. 5 and 6 show views of different embodiments of terminal regions of a main body of the cooling module according to FIGS. 4A through 4F;

FIG. 7 shows parts of the cooling module according to FIGS. 4A through 4F in an exploded view;

FIGS. 8A and 8B show views of parts of the cooling module according to FIGS. 4A through 4F; and

FIGS. 9A to 9C show views of the main body of the cooling module according to FIGS. 4A through 4F.

### DETAILED DESCRIPTION

In an embodiment, the present invention enables high currents in plug connector systems with a simultaneously minimum weight.

A cooling module for a plug connector part is accordingly provided which has a main body. The main body comprises a cavity in which at least one terminal region for electrical contacting is formed by an electrical load line. Furthermore, the cooling module, and in particular the main body, comprises at least one opening into the cavity via which a coolant can flow through the cavity, and a mounting surface for mounting an electrical load contact.

In this way, a cooling module for a plug connector part is provided, in which the section of an electrical load cable which is electrically connected or connectable to the plug connector can be actively cooled. This makes it possible to actively cool the load cable over its entire length, whereby, for example, the cross-section of the load cable can be reduced overall while the current carrying capacity remains the same. This enables high currents with simultaneously reduced weight. Since, in particular, the connection of the electrical load line can be completely integrated into the coolant circuit, separation of the cooling circuit from the electrical load line is therefore not necessary.

The connector part may be a high-amperage and/or high-voltage connector part. For example, the plug connector part is designed to conduct electrical currents with a power of 10 kW or more, and in particular of 50 kW or more, 135 kW or more, or 350 kW or more. For example, the plug connector part is designed to conduct electrical currents with current strengths of 100 A or more, and in particular 500 A or more—for example, 3,000 A. The coolant is for example a cooling fluid.

A contact section of an electrical load line can rest on the at least one terminal region of the main body of the cooling module. Optionally, the contact section of the main body is integrally connected to the contact section of the load line. For example, the contact section of the main body is soldered and/or welded to the contact section of the load line.

In a further development, the electrical load line extends through the opening. Alternatively or additionally, the electrical load line is surrounded at least in sections by a coolant line. This enables a continuously cooled load line and also a compact design.

According to one embodiment, the at least one terminal region has a planar bottom surface. With the planar bottom surface, a contact section of the electrical load line can be welded—for example, by means of ultrasonic welding. This enables a secure and durable connection.

In an alternative embodiment, the at least one terminal region has a concave bottom surface, e.g., a bottom surface which follows a circular arc in cross-section, and in particular describes a semicircle. A contact section of the electrical load line can be soldered, for example, to a base surface formed in this way. This also enables a secure and durable connection.

The cooling module comprises, for example, a cover. The cover can be designed such that it closes the cavity—in particular, fluid-tight. The cavity defines an interior space of the main body. The main body is therefore hollow. The interior space can be closed by the cover. For example, the cavity is accessible via an access opening which is arranged separate from the opening for the coolant. The access opening can be closed by the cover. As a result, the electrical load line can first be connected to the terminal region, whereupon the cavity can then be closed by the cover. The cover is, for example, screwed to the main body. The cover comprises, for example, a plastic or consists thereof, which enables further weight reduction.

A hose connector can be mounted or is mounted on the opening—for example, by means of a screw thread. This permits simple and secure mounting.

The opening is optionally aligned with the at least one terminal region. This enables a particularly easy connection of the electrical load line.

Optionally, the main body (for example, in addition to the access opening) comprises at least two openings opening into the cavity. For example, one opening can be used as the inlet for the coolant, and a further opening can be used as an outlet for the coolant. In this case, it can be provided that coolant introduced through the inlet in an inlet direction flow out of the outlet in an outlet direction, which is directed, for example, against the inlet direction. The opening serving as an inlet and the opening serving as an outlet are, for example, formed on the same side surface of the main body.

According to a development, the two openings are each aligned with one of two terminal regions. In this way, two load lines can be electrically connected to the main body. Volumes adjoining the two terminal regions within the cavity are in fluidic communication with one another—for example, via a channel. As a result, coolant can be guided directly via both terminal regions.

The main body consists, for example, of an electrically-conductive material, e.g., copper. Via the material of the main body, an electrical load line electrically contacting the terminal region can be electrically connected to an electrical load contact to be mounted on the mounting surface. This enables a particularly good electrical connection of the load contact to the load line. The load contact is designed, for example, to be connected to a mating load contact. The main body can be designed as a single piece.

An electrical load contact can be pre-mounted on the mounting surface. This enables in particular easy mounting on the plug connector part.

According to one aspect, a plug-in connector part is provided for connecting to a mating connector part. The plug connector part comprises a housing and one or more (e.g., exactly two or more) cooling modules arranged in particular in the housing, in each case according to any embodiment described herein.

For example, a load contact is mounted on the cooling module or each of the multiple cooling modules, e.g., in each case screwed thereto.

Optionally, the connector part is designed as a vehicle charging socket or vehicle charging plug—in particular, for high-current charging by means of direct current. This is where the potential saved weight especially comes into play.

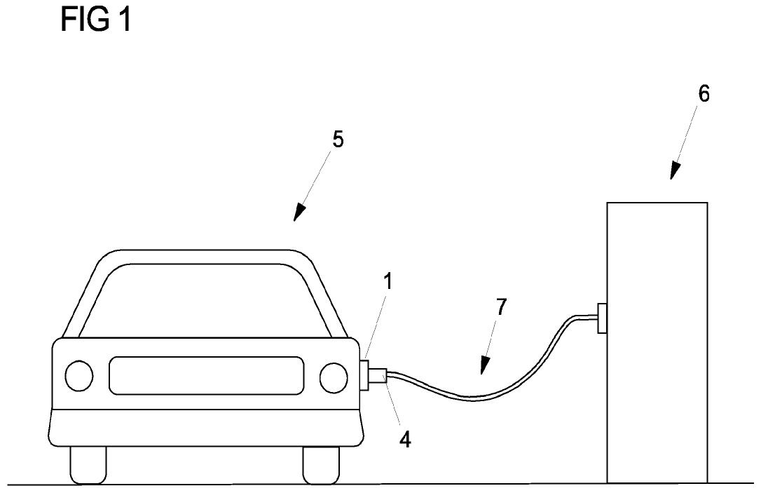

FIG. 1 shows an electrically driven vehicle 5, also referred to as an electric vehicle, with a connector system having a connector part 1, here in the form of a vehicle charging socket, for detachable electrical connection to a mating connector part 4 (here in the form of a vehicle charging plug). The plug connector part 1 and the mating plug connector part 4 together form a plug connector. In addition, FIG. 1 shows a charging station 6 which serves to charge the vehicle 5. The charging station 6 is designed to provide a charging current in the form of a direct current (alternatively or additionally, an alternating current). The charging station 6 can be electrically connected to the vehicle 5 via a cable 7, one end of which is connected to the charging station 6 and the other end of which is connected to the mating connector part 4. In the shown example, the mating plug connector part 4 is designed as a manually pluggable vehicle charging plug for the electric vehicle 5. On the side of the charging station 6, the cable 7 is permanently connected to the charging station 6, or alternatively connected, for example, via a plug connector 1, 4 of the same or similar design.

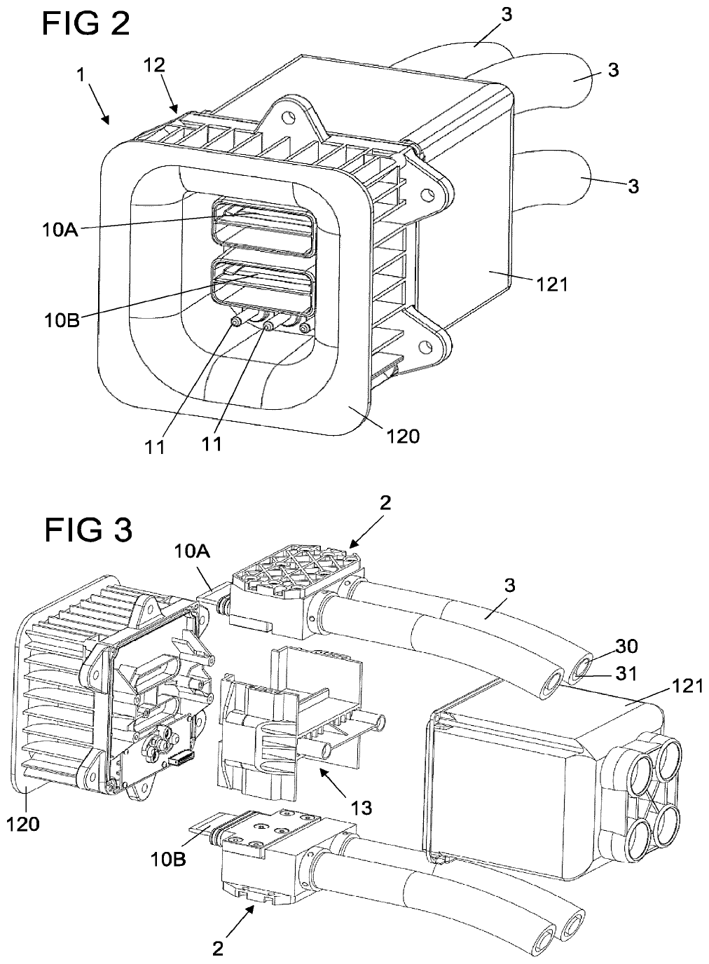

FIGS. 2 and 3 show the plug connector part 1. In the present case, the plug connector part 1 is designed for mounting on the vehicle 5.

The plug connector part 1 is designed to transmit a charging current in the form of a direct current and/or in the form of an alternating current. It represents an actively-cooled charging plug connector part. In the present case, the plug connector part 1 is connected to a coolant circuit of the vehicle 5 and to a power supply (e.g., DC power supply) of the vehicle 5.

The plug connector part 1 comprises a housing 12. The housing 12 forms a terminal region for the mating plug connector part 4. Two load contacts 10A, 10B serve to construct a circuit. The load contacts 10A, 10B are pluggably connectable to mating load contacts of the mating connector 4. In the present case, the load contacts 10A, 10B are high-current load contacts. They can conduct currents of 50 A or more, in particular 100 A or more, and in particular 500 A or more, e.g., 3,000 A, during, and in particular for the duration of, a charging or discharging process. Further plug contacts 11 serve, for example, as protective conductors (PE), alternating current contacts or three-phase current contacts, and/or as data connections. The load contacts 10A, 10B are each formed flat with planar upper and lower sides (and also parallel to each other in the shown example). The load contacts 10A, 10B are arranged with their planar surfaces parallel to one another.

For connection to the power grid, supply lines 3 are connected to the plug connector part 1; in the present case, at least two, and specifically four, supply lines 3. Each pair of supply lines 3 serves to connect the positive and negative poles of a direct-current connection. The supply lines 3 are connected in one direction to the plug connector part 1 which is aligned (approximately) along an insertion direction of the mating plug connector part 4 to the plug connector part 1.

In the present case, the housing 12 comprises a front housing part 120 which forms the terminal region for the mating plug connector part 4, and a rear housing part 121 in which openings are formed through which the supply lines 3 are guided into the housing 12. Mounting sections for mounting on a wall are formed on the housing 12 (specifically, on the front housing part 120), and specifically in the form of laterally-protruding tabs with holes formed therein for screwing.

The housing 12 forms an interior space within which two cooling modules 2 are arranged. The two cooling modules 2 are separated from one another by a separating element 13, and in particular electrically insulated from one another. In the present case, the separating element 12 and the housing 12 are made of an electrically-insulating material. In the shown example, the separating element 13 describes the shape of an H.

One of the load contacts 10A is mounted in flat contact with one of the cooling modules 2, and, more precisely, screwed thereto. The other of the load contacts 10B is mounted in flat contact with the other of the cooling modules 2, and, more precisely, screwed thereto.

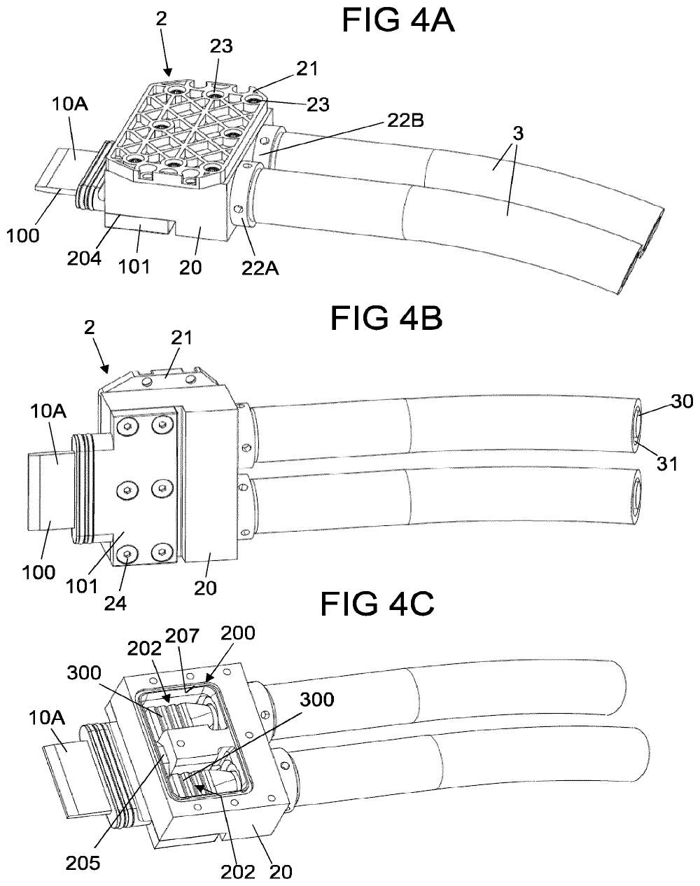

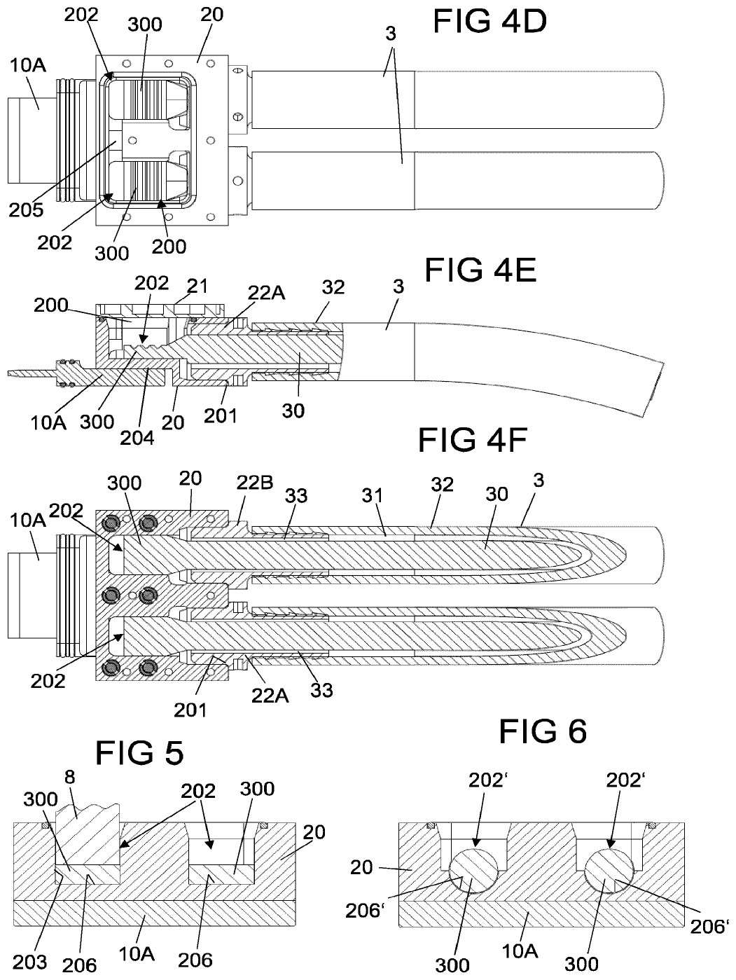

In the present case, the cooling modules 2 (and also the load contacts 10A, 10B) are structurally identical. In connection with FIGS. 4A through 9C, the cooling module 2 with the one load contact 10A will now be described in detail by way of example, wherein the following explanations also apply analogously to the cooling module 2 with the other load contact 10B.

The cooling module 2 comprises a main body 20, a cover 21, and two hose connectors 22A, 22B. In the assembled state (see, for example FIGS. 4A, 4B and 8A), the cover 21 is fastened to the main body 20 by means of screws 23, and the load contact 10A is fastened to the main body 20 by means of screws 24. One of the supply lines 3 is connected to the cooling module 2 at each of the hose connectors 22A, 22B. The main body 20 comprises screw holes for the cover 21; see, for example, FIGS. 4C, 4D and 8B.

In the present case, the main body 20 is substantially cuboid. The main body 20 is formed in one piece (and in the present case, also integrally). A mounting surface 204, on which the load contact 10A is mountable (and mounted), is formed on one side of the main body 20. In the present case, the mounting surface 204 is formed on a recessed region; the side of the main body 20 with the mounting section 204 has a step. Screw holes for the screws 24 are formed on the mounting section 204. When in an installed state, the mounting surface 204 both transmits electrical current from the cooling module 2 to the load contact and dissipates heat from the load contact 10A to the cooling module 2. An actively-cooled load contact 10A, 10B is therefore made possible.

The load contact 10A comprises a contact section 100 and a mounting section 101. The mounting section 101 of the load contact 10A is fastened to the mounting section 204 of the main body 20. Between the contact section 100 and the mounting section 101 of the load contact 10A, a seal (more precisely, two seals) is arranged which seals (seal) the load contact 10A in the assembled state (see, for example, FIG. 2) relative to the housing 12. The load contact 10A is formed in one piece.

A cavity 200 is formed in the main body 20. The cavity 200 opens at an access opening 207. When the cover 21 is not mounted, the cavity 200 is accessible via the access opening 207; see, for example, FIGS. 4C and 4D. The cavity 200 defines an interior space of the main body 20. Two terminal regions 202 are provided within the cavity 200. An electrical load line 30 with an end serving as the contact section 300 is fastened to each of the terminal regions 202.

In the present case, the main body 20 is produced from copper (in particular, pure copper; alternatively, from another conducting material). The contact sections 300 of the load lines 30 are electrically contacted with the respective terminal region 202. The contact sections 300 of the load lines 30 are welded to the respective terminal region 202. A welding tool or another tool can be inserted through the access opening 207 during the production of the connected cooling module 2 in order to weld or solder the load lines 30 to the main body. After the fixed connection of the load lines to the terminal regions 202 of the main body in the interior of the cavity 200, the cover 21 is mounted—in particular, fluid-tight (here, by an intermediate layer of a seal).

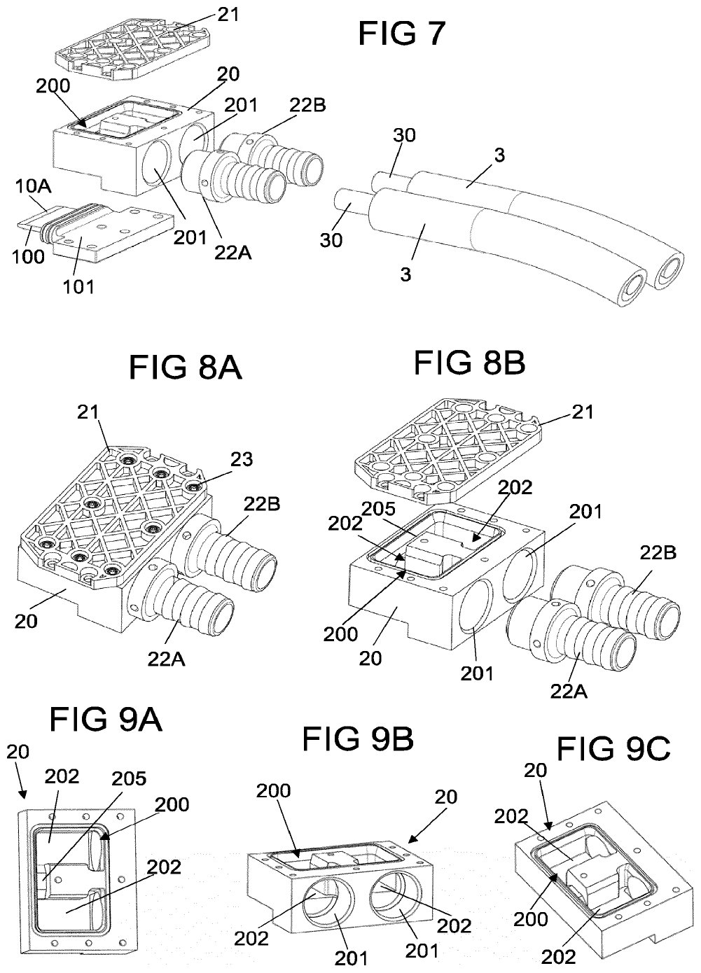

The load lines 30 project through openings 201 (see in particular FIGS. 4E, 4F and 9A-9C) in the main body 20 into the cavity 200, and specifically, in the shown example, through the openings 201 in which the hose connectors 22A, 22B are mounted (see, for example, FIGS. 7 and 8B). The openings 201 therefore open into the cavity 200 and are in fluidic communication with the cavity 200 (see in particular FIG. 9B). The openings 201 are each aligned with the corresponding terminal region 202 (see, for example, FIGS. 4E, 4F and 9A-9C).

The openings 201 are formed on the (same) side of the main body 20, and, in the present case, a narrow side. The openings 201, the access opening 207, and the mounting surface 204 are formed on different sides of the main body 20. In the present case, the side of the main body 20 with the openings 201 is arranged between the sides of the main body 20 with the access opening 207 and the mounting surface 204. In the shown example, the mounting surface 204 and the access opening 207 are formed on opposite sides of the main body 20. The access opening 207 is larger than each of the openings 201, and also larger than both openings 201. The openings 201 are circular-cylindrical, and, in the present case, in the form of bores. The openings 201 each have an internal thread, for example, into which the respective hose connector 22A, 22B is screwed.

The electrical load lines 30 are each guided in one of the supply lines 3. The supply lines 3 are actively coolable and cooled by means of a coolant. For this purpose, a sheath 32 surrounds the respective load line 30 in each of the feed lines 3, wherein a free space is formed between the load line 30 and the sheath 32 and serves as a coolant line 31 (see in particular FIGS. 4E and 4F). In the present case, an inner diameter of the sheath 32 is greater than an outer diameter (at the same location of the feed line 3) of the load line 30. As a result, the load line 30 can be particularly effectively cooled by a coolant in the form of a cooling fluid, and in particular a cooling liquid.

The sheath 32 of each feed line 3 is connected to the respective hose connector 22A, 22B, and, more precisely, plugged on. The corresponding load line 30 extends through the hose connector 22A, 22B into the cavity 200 of the main body 20. The coolant line 31 of each feed line 3 of the cooling module 2 is in fluidic communication with the cavity 200. A free space 33 is formed between the respective load line 30 and the corresponding hose connector 22A, 22B. The coolant can flow through this free space 33. In the present case, the outer diameter of the respective load line 30 in the interior of the corresponding hose connector 22A, 22B is smaller than the inner diameter of the hose connector 22A, 22B.

The two openings 201 are each aligned with one of the two terminal regions 202, wherein the two terminal regions 202 are in fluidic communication with one another via a channel 205 (see, for example, FIGS. 4C and 4D). The coolant lines 31 of the supply lines 3 of the cooling module 2 are therefore in fluidic communication with one another via the cavity 200. One of the coolant lines 31 serves to supply coolant and the other of the coolant lines 31 serves to discharge the coolant. One of the two openings 201 therefore serves as an inlet, and the other one as an outlet. The openings 201 are formed on the same side of the main body 20 so that coolant introduced through the inlet in an inlet direction flows out of the outlet in an outlet direction which is directed counter to the inlet direction.

The coolant therefore flows over the thermally critical connection of a first load line 30, is diverted to the other side in the cavity 200 of the main body 20 and then flows over the connection of a second load line 30, which is otherwise optional (and, alternatively, the coolant is introduced in the reverse direction). The cooling module 2 can therefore be operated both with one and also two electrical load lines 30. However, there is also no restriction to two load lines 30, and more can also be provided (e.g., via more openings 201). The coolant is supplied and also discharged with at least two coolant lines. In this case, also, more than two coolant lines 31 are conceivable. The arrangement of the cavity 200 and the openings 201 in the form of the bores is configured such that the electrical load lines 30 and the coolant each enter the cooling module 2 at least largely coaxially to one another in the bore axes of the openings 201. The electrical load lines 30 are located outside the cooling module 2 directly in the free volume of the coolant tubes (of the sheaths 32). The coolant is in particular not electrically conductive, but electrically insulating.

The multiple load lines 30 of a cooling module 2 are electrically connected to one another via the main body 30 and are subjected to the same electrical potential.

FIG. 5 shows the terminal regions 202 in detail in cross-section. The terminal regions 202 are adapted to the method of joining the load line 30 and main body 20 and in the present case each comprise a planar bottom surface 206 with lateral wire confinement by lateral wire confinement surfaces 203 for ultrasonic welding, e.g., by means of the welding stamp 8 shown in FIG. 5. The wire confinement surfaces 203 prevent the wire bundle of the load line 30 from escaping under the welding stamp 8.

FIG. 6 shows an alternative embodiment of terminal regions 202′ in detail in cross-section. These terminal regions 202′ are also adapted to the method of joining the load line 30 and main body 20, and in the present case each comprise a concave, trough-shaped bottom surface 206′ for soldering the respective load line (specifically, the corresponding contact section 300).

Thus, a module-like component is provided with the cooling module 2 and combines and integrates the functions of an electrical (optionally, multiple) connection for cooled load lines 30, the electrical current conduction, the cooling of a load contact 10A, 10B, and the guidance of a cooling fluid, and, in a high-performance plug connector, can be fixedly connected to the load contact 10A, 10B to be cooled, e.g., flange-mounted thereon.

It should be mentioned that, alternatively, it is also possible to provide in the main body 20 only the access opening 207 to the cavity 200 (and not to provide the openings 201 in the main body 20) and to create the connections of the coolant line, for example, via another component, such as a suitably designed cover 21.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Plug connector part
10A, 10B Load contact
100 Contact section
101 Mounting section
11 Plug contact
12 Housing
120 Front housing part
121 Rear housing part
13 Separating element
2 Cooling module
20 Main body
200 Cavity
201 Opening
202, 202′ Terminal region
203 Wire confinement surface
204 Mounting surface
205 Channel
206; 206′ Floor surface
207 Access opening
21 Cover
22A, 22B Hose connector
23, 24 Screw
3 Feed lines
30 Load line
300 Contact section
31 Coolant line
32 Sheath
33 Free space
4 Mating plug connector part
5 Vehicle
6 Charging station
7 Cable
8 Welding stamp

1. A cooling module for a plug connector part, comprising:
a main body having a cavity in which at least one terminal region is formed for electrical contacting by an electrical load line;
at least one opening into the cavity via which a coolant can flow through the cavity; and
a mounting surface configured to mount an electrical load contact.

2. The cooling module of claim 1, further comprising:
at least one electrical load line with a contact section resting against the at least one terminal region of the main body.

3. The cooling module of claim 2, wherein the at least one electrical load line extends through the opening and is surrounded at least sectionally by a coolant line.

4. The cooling module of claim 1, wherein the at least one terminal region has a planar bottom surface.

5. The cooling module of claim 1, wherein the at least one terminal region has a concave bottom surface.

6. The cooling module of one of the preceding claims, further comprising: a cover which closes the cavity fluid-tight.

7. The cooling module of claim 1, wherein a hose connector is mountable or mounted in the opening.

8. The cooling module of claim 1, wherein the opening is aligned with the at least one terminal region.

9. The cooling module of claim 1, wherein the opening comprises an inlet or outlet for the coolant,
wherein a further opening correspondingly comprises an outlet or inlet for the coolant, and
wherein coolant introduced through the inlet in an inlet direction flows out of the outlet in an outlet direction which is directed counter to the inlet direction.

10. The cooling module of claim 9, wherein the two openings are each aligned with one of two terminal regions, and
wherein the two terminal regions are in fluidic communication with one another via a channel.

11. The cooling module of claim 1, wherein the main body comprises an electrically conductive material such that the electrical load line electrically contacting the terminal region is electrically connectable via the electrically-conductive material of the main body to an electrical load contact to be mounted on the mounting surface.

12. The cooling module of claim 1, further comprising:
a load contact mounted on the mounting surface.

13. A plug connector part for connecting to a mating connector part, comprising:
a housing; and
at least one cooling module of claim 1 arranged on the housing.

14. The plug connector part of claim 13, wherein a load contact is screwed to the at least one cooling module.

15. The connector part of claim 13, wherein the plug connector part comprises a vehicle charging socket or vehicle charging plug.
